(19) United States
(12) Patent Application Publication
(10) Pub. No.: US 2011/0093808 A1
(43) Pub. Date: Apr. 21, 2011

(54) SYSTEMS AND METHODS FOR INDICATING AND PREDICTING VIEWS

(76) Inventor: Vincent Monical, Piedmont, CA (US)

(21) Appl. No.: 12/857,551

(22) Filed: Aug. 16, 2010

Related U.S. Application Data
(60) Provisional application No. 61/234,095, filed on Aug. 14, 2009.

(51) Int. Cl. G06F 3/048

(52) U.S. Cl. 715/781

(57) ABSTRACT

A system includes presentation of a proposition associated with at least two alternative answers, and reception, from a user, of an indication of a degree of agreement with at least one of the alternative answers, the degree of agreement being greater than zero percent and less than one hundred percent. Also included is reception, from the user, of a prediction of a composite degree of agreement with at least one of the alternative answers, the composite degree of agreement being greater than zero percent and less than one hundred percent.

In some aspects, an indication of a degree of agreement with at least one of the alternative answers is received from each of a plurality of other users, and the composite degree of agreement is determined based on the indications of degrees of agreement received from the plurality of other users.

Further aspects may receive, from each of the plurality of other users, a prediction of a composite degree of agreement with at least one of the alternative answers, and identify, from among the received predictions of the composite degree of agreement, a received prediction of the composite degree of agreement that is closest to the determined composite degree of agreement.

### CROSS-REFERENCE TO RELATED APPLICATION

The present application claims priority to U.S. Provisional Patent Application Ser. No. 61/234,095, filed on Aug. 14, 2009 and entitled “System for Submitting and Predicting Opinion”, the contents of which are incorporated herein by reference for all purposes.

### BACKGROUND

Many conventional systems leverage the World Wide Web to facilitate personal interaction. Online forums, social networking sites, multiplayer gaming sites, and dating sites are examples of some currently-popular vehicles for providing interpersonal communication. Other Web-based systems, such as Twitter, Foursquare, etc., focus more specifically on broadcasting personal and oftentimes fleeting information, such as current thoughts, current location, etc. Accordingly, while functional overlaps may exist, the above-mentioned Web-based systems may be roughly categorized as either focused on building and encouraging user communities, or on facilitating the dissemination of user-centric information.

Systems are desired for promoting user expression while also focusing user attention on a community and on the views of others.

### BRIEF DESCRIPTION OF THE DRAWINGS

FIG. 1 is a block diagram of a system according to some embodiments.

FIG. 2 is a flow diagram of a process according to some embodiments.

FIG. 3 is a generalized view of a user interface according to some embodiments.

FIGS. 4 through 13 are outward views of application screenshots according to some embodiments.

FIGS. 14 through 17 are outward views of a social network-based implementation according to some embodiments.

FIG. 18 is a block diagram of a system architecture according to some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art.

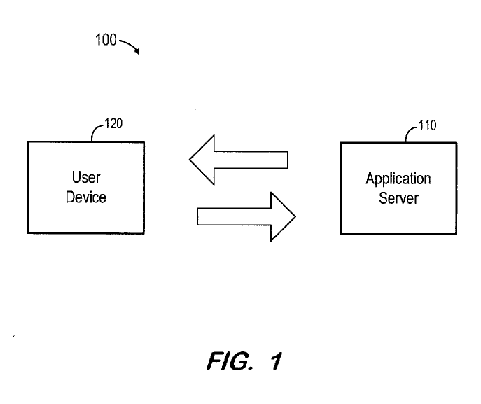

FIG. 1 is a block diagram of a hardware architecture of system 100 according to some embodiments. System 100 includes application server 110 and user device 120. Application server 110 and user device 120 may each be implemented using any number of computing devices, each of which consists of any suitable combination of hardware and/or software. Although FIG. 1 depicts the flow of data directly between application server 110 and user device 120, such data may pass through any number of devices, networks, applications, etc. as it travels between application server 110 and user device 120. Embodiments are not limited to the architecture of system 100.

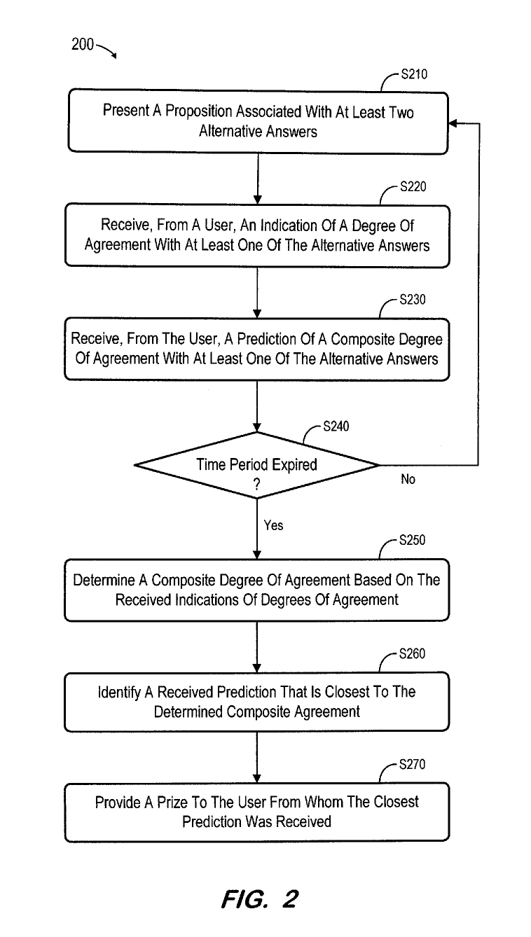

FIG. 2 is a flow diagram of process 200 according to some embodiments. Process 200, and all other process described herein, may be executed by hardware and embodied in program code stored on a non-transitory computer-readable medium. Process 200, and the other described processes, may be performed by one or more elements of system 100, such as application server 110, but embodiments are not limited thereto.

Initially, at S210, a proposition associated with at least two alternative answers is presented. According to some embodiments, user device 120 comprises a desktop computer, a laptop computer, a personal digital assistant, a tablet PC, or a smartphone. Prior to S210, a user may operate user device 120 to, for example, execute program code of a rich client application or a Web-browser in order to request a Web page from application server 110. Consequently, application server 110 provides the requested Web page to user device 120.

Embodiments are not limited to any particular type or form of proposition. For example, the proposition may be a “yes/no” question stated in any understandable form (e.g., “Are the Miami Heat going to win the 2011 NBA title?”, “Do you think that the Miami Heat are going to win the 2011 NBA title?”, etc.), or a statement to which either of the alternative answers “yes” or “no” is an appropriate response (e.g., “The Miami Heat are going to won the 2011 NBA title.”).

In some embodiments, the proposition may simply propose a choice between the at least two alternative answers (e.g., “Which was better, Star Wars, Episode IV or Star Wars, Episode I?”, “Who is the best golfer of all time, Jack Nicklaus or Tiger Woods?”, etc.). Any suitable mechanism for prompting a user to consider at least two alternative answers may be considered a “proposition” according to some embodiments.

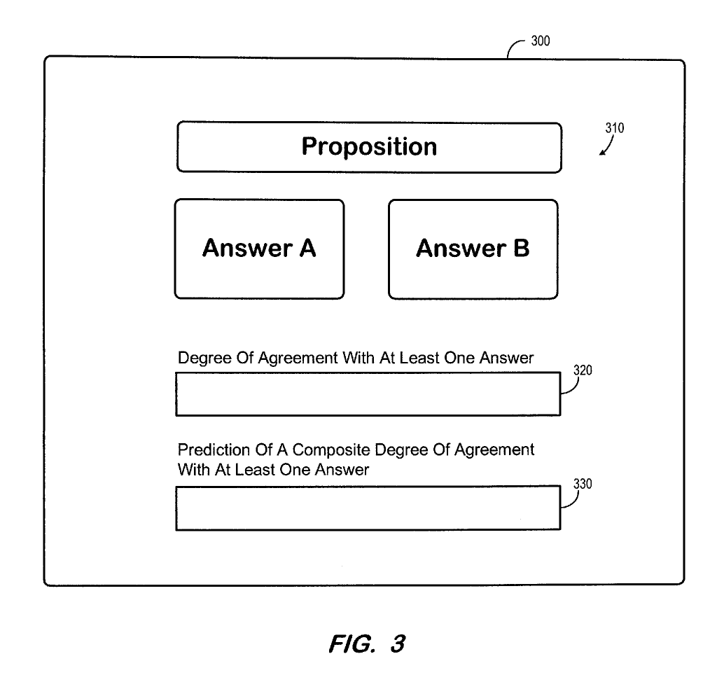

FIG. 3 is a conceptual diagram of user interface 300 presented according to some embodiments of S210. User interface 300 may comprise a Web page provided by application server 110, but embodiments are not limited thereto. As illustrated, user interface 300 presents user interface portion 310 including a proposition associated with at least two alternative answers (i.e., Answer A and Answer B).

Returning to process 200, an indication is received from a user at S220. The indication indicates a degree of agreement with at least one of the alternative answers. For example, user interface 300 includes user interface portion 320 to receive such an indication from the user. Other examples of a user interface portion to receive an indication of a degree of agreement are described below.

The degree of agreement may comprise a percentage reflecting the extent to which the user agrees with at least one of the alternative answers. For example, it will be assumed that user interface portion 310 includes the proposition “Are the Miami Heat going to win the 2011 NBA title?”, Answer A is “No”, and Answer B is “Yes”. The user may enter “No, 65%” in user interface portion 320 to indicate 65% agreement with the answer “No” as it pertains to the proposition. Of course, such an indication may also be understood to indicate a 35% degree of agreement with the answer “Yes” with respect to the proposition. Alternatively, the user may enter “65%/35%” in portion 320 to indicate his/her degree of agreement with each of the alternative answers. Embodiments may employ any suitable manner of indicating a degree of agreement with at least one of the alternative answers associated with the proposition. Advantageous user interfaces for inputting and receiving such an indication will be described below.

A prediction is received from the user at S230. The prediction is a prediction of a composite degree of agreement with at least one of the alternative answers. The composite degree of agreement is based on indications of degrees of agreement with the at least one alternative answer which are received from other users. In other words, a prediction of how other users will respond to the proposition is received at S230.

Continuing with the present example, the user may enter “No, 55%” in user interface portion 330 to indicate 55% agreement with the answer “No” as it pertains to the proposition. Of course, such an indication may also be understood to indicate a 45% degree of agreement with the answer “Yes” with respect to the proposition. Alternatively, the user may enter the prediction “55%/45%” in portion 330. Embodiments may employ any suitable manner of inputting and receiving the prediction of the composite degree of agreement. Advantageous user interfaces for inputting and receiving such prediction will also be described below.

Embodiments may employ user interfaces and user interface portions that differ significantly from user interface 300. For example, user interface portion 310 may be initially presented in a user interface, followed by user interface portion 320. Then, after the indication is received at S220, user interface portion 330 is presented to receive the prediction at S230. As mentioned above, user interface portions for receiving the indication and the prediction at S220 and S230, respectively, may differ in any manner from either or both of user interface portion 320 and user interface portion 330.

The presented proposition may be associated with a particular time period. During the time period, indications and predictions from many users may be received and stored. However, at the conclusion of the time period, a composite degree of agreement is determined based on some or all of the received indications.

Accordingly, at S240, it is determined whether the time period has expired. If not, flow returns to execute S210, S220 and S230 as described above with respect to a new user. More specifically, an indication of a degree of agreement and a prediction of the composite degree are received from the new user. The new user may operate a user device different from the user device operated by the previously-described user. It should be understood that, via Web-based protocols, for example, steps S210 through S230 may be performed virtually simultaneously with respect to many different users and user devices, until it is determined that S240 that the time period has expired.

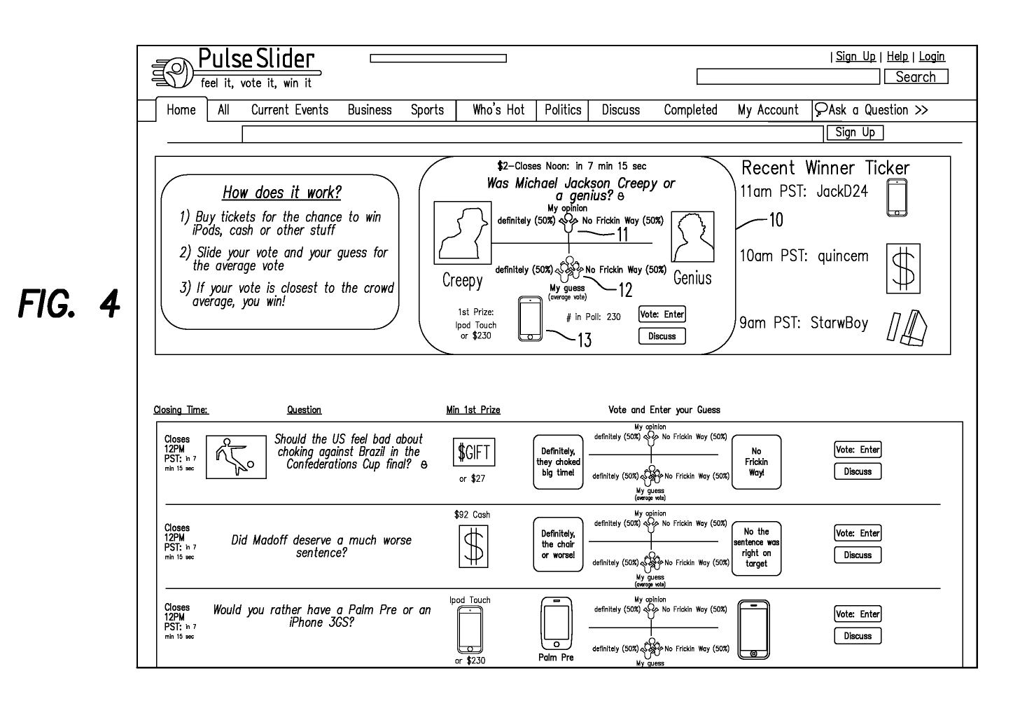

FIGS. 4 through 7 will now be described to illustrate additional examples of S210 through S230 according to some embodiments. Embodiments are not limited to any of the interfaces shown in FIGS. 4 through 7. FIG. 4 shows a sample home page of a website according to some embodiments. Systems are not limited to Web-based implementations. Window 10 presents a proposition (i.e., “Was Michael Jackson creepy or a genius?”) and two alternative answers (“Creepy” and “Genius”) as described above. Slider interface control 11 is a user interface portion which allows a user to submit an indication of his degree of agreement with at least one of the alternative answer.

More particularly, the user may select and drag control 11 to the left in order to indicate an increased degree of agreement with one answer (i.e., “Creepy”) and a decreased degree of agreement with the other answer (i.e., “Genius”). Similarly, the user may select and drag control 11 to the right in order to indicate an increased degree of agreement with one answer (i.e., “Genius”) and a decreased degree of agreement with the other answer (i.e., “Creepy”).

In some embodiments, the percentages displayed next to control 11 are decremented and incremented accordingly in response to movement of control 11. In some embodiments, the font sizes of the text and/or other associated icons decrease and increase to reflect the changed percentages. According to some embodiments, the color of the text and/or other associated icons may dynamically change based on movement of control 11. For example, the proposition on the right may be associated with the color blue and the proposition on the left may be associated with the color red. The percentages associated with each proposition and any accompanying text may be colored red if control 11 is moved right of center, and blue if control 11 is moved left of center. This coloring may occur in addition to or instead of the size changes mentioned above.

Control 11 may allow the user to indicate a degree of agreement with an answer to any suitable level of granularity. For example, the scale along which control 11 slides may be substantially continuous and include 100 distinct positions (e.g., . . . , 49/51, 50/50, 51/49, . . . ), 1000 distinct positions (e.g., . . . , 49.9/50.1, 50/50, 51.1/49.9, . . . ), 10000 distinct positions (e.g., . . . , 49.99/50.01, 50/50, 51.01/49.99, . . . ), or any other number of distinct positions. An increased number of positions provides more information as to the user's particular degree of agreement.

Interface control 12 of window 10 allows the user to submit a prediction of a composite degree of agreement with at least one of the answers. The composite degree of agreement is determined based on indications at S220 from each of two or more users.

Again, the user may select and drag control 12 to the left to submit a prediction that a set of participating users will agree more with one answer (i.e., “Creepy”) than with the other answer (i.e., “Genius”). The percentages displayed next to control 12 may be decremented and incremented in response to movement of control 12, the font sizes of accompanying text/icons may decrease and increase to reflect the changed percentages, and colors of the accompanying text/icons may change to reflect the changed percentages.

Control 12 may also allow the user to specify his prediction to any suitable level of granularity. The granularity provided by control 12 may be substantially continuous and less than, equal to, or greater than the granularity provided by control 11. High granularity of control 12 may advantageously allow a high number of distinct predictions. A high number of distinct predictions may allow awarding of more valuable prizes than would otherwise be awarded. In this regard, an increase in the number of potentially “losing” predictions may result in an increase in the revenue collected per “winning” prediction.

The indication and prediction may be received from the user upon selection of Vote: Enter button of window 10. An account of the user may be debited upon receipt of the indication and prediction. That is, a user may provide real or virtual currency or goods in exchange for eligibility to win a prize.

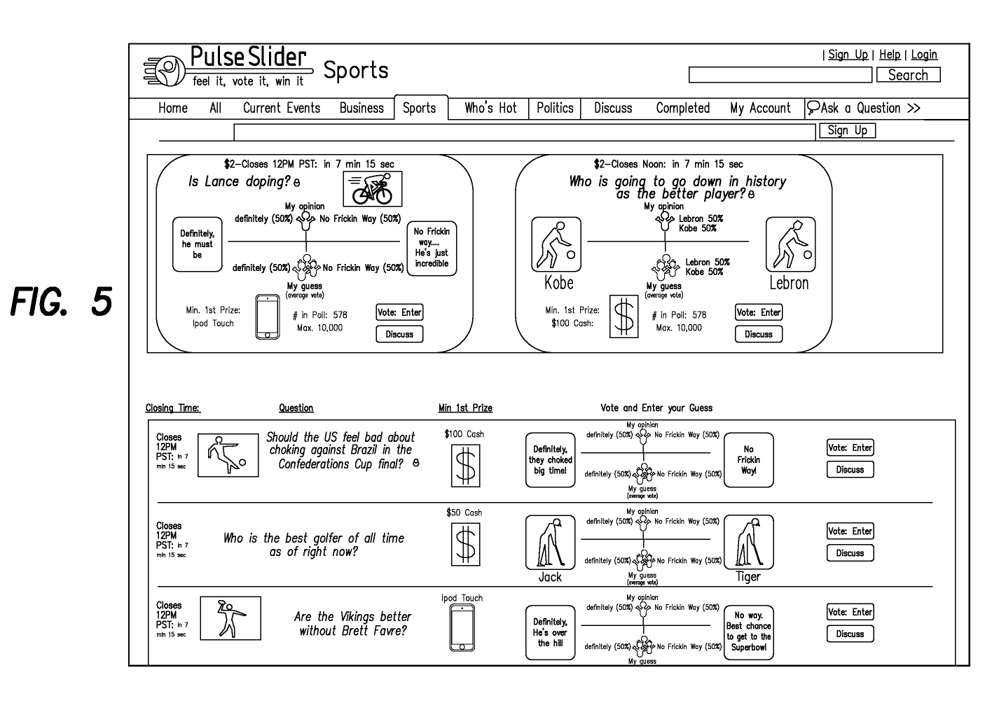

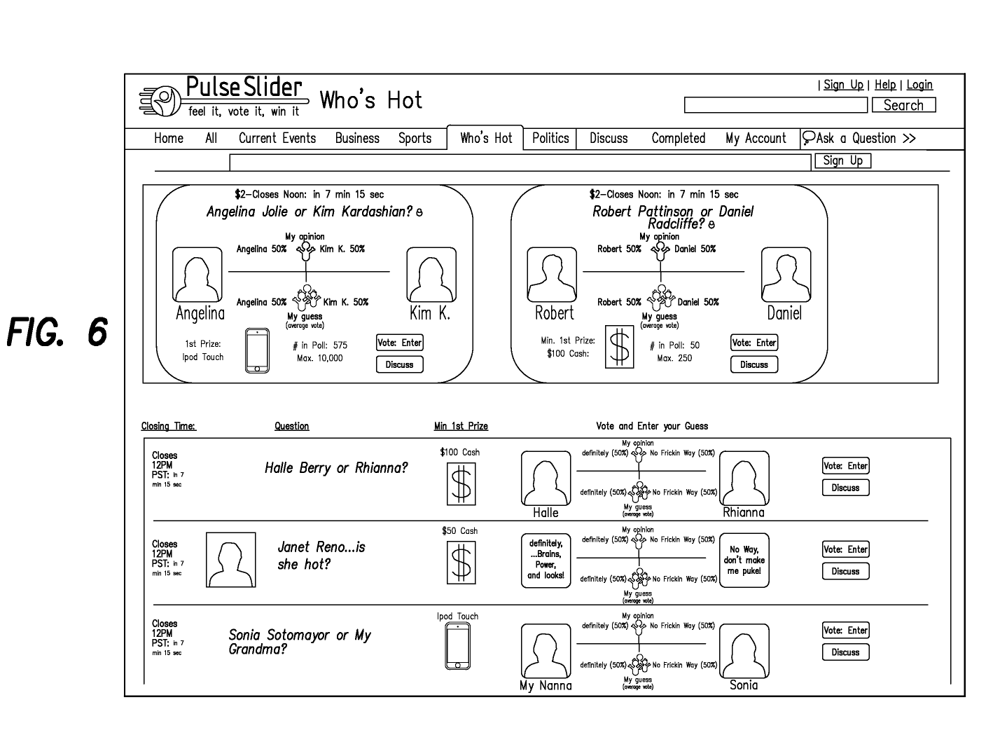

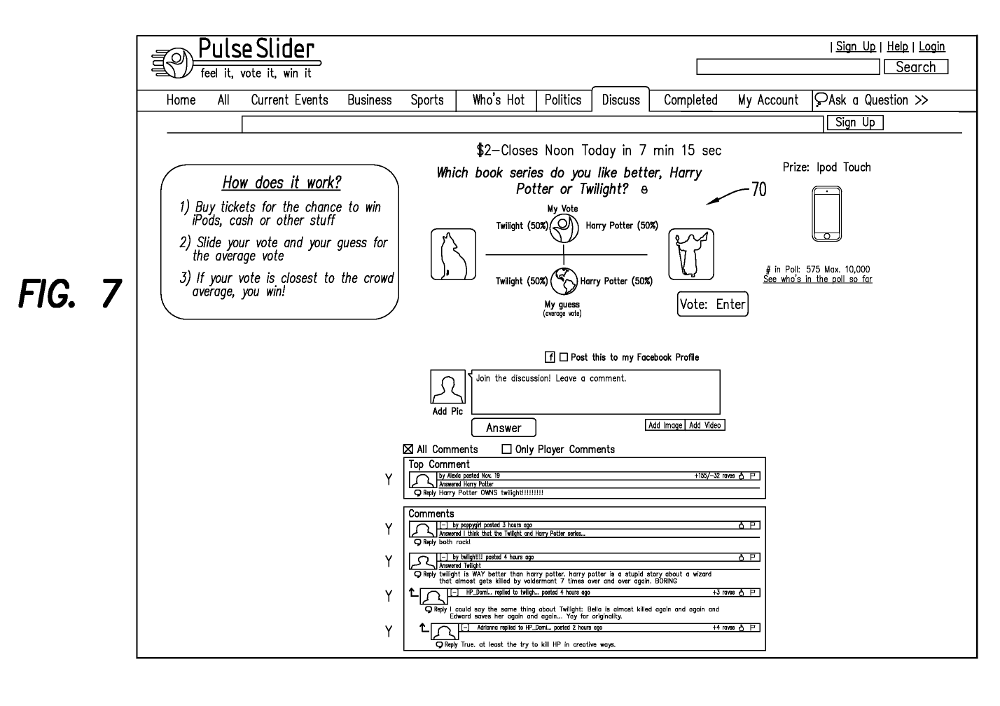

FIG. 5 shows interfaces for submitting indications and predictions associated with sports-related propositions. Similarly, FIG. 6 shows interfaces for submitting indications and predictions associated with celebrity-related propositions. FIG. 7 illustrates interface 70 for submitting an indication and a predictions as described above. FIG. 7 also provides an interface for discussing the proposition amongst other users. The interface indicates whether a particular comment was received from a user (i.e., “Player”).

Returning to process 200, a composite degree of agreement is determined at S250 based on the indications received at S220. The composite degree of agreement may be the average of all received indications, or any other mathematical result calculated based on some or all of the received indications. Next, at S260, a received prediction that is closest to the determined composite agreement is identified. Any suitable tiebreaking algorithm, if necessary, may be employed to resolve ties or the like.

A prize is provided to the user from whom the closest prediction was received at S270. Some embodiments may also provide prizes for second closest prediction, third closest prediction, etc.

Window 10 of FIG. 4 identifies prize 13. The identity of prize 13 may be based on the number of received indications/predictions. In some embodiments, a same user may enter more than one indication/prediction. Such a user may be charged for each submitted indication/prediction. For example, it may be determined that prize 13 is awarded if the received number of indications/predictions exceeds 200 and is less than 500. Accordingly, if the number of indications/predictions exceeds 500, another prize may be identified in window 10. During the time period over which indications/predictions are received, some embodiments may dynamically update the displayed prize based on a current number of received indications/predictions.

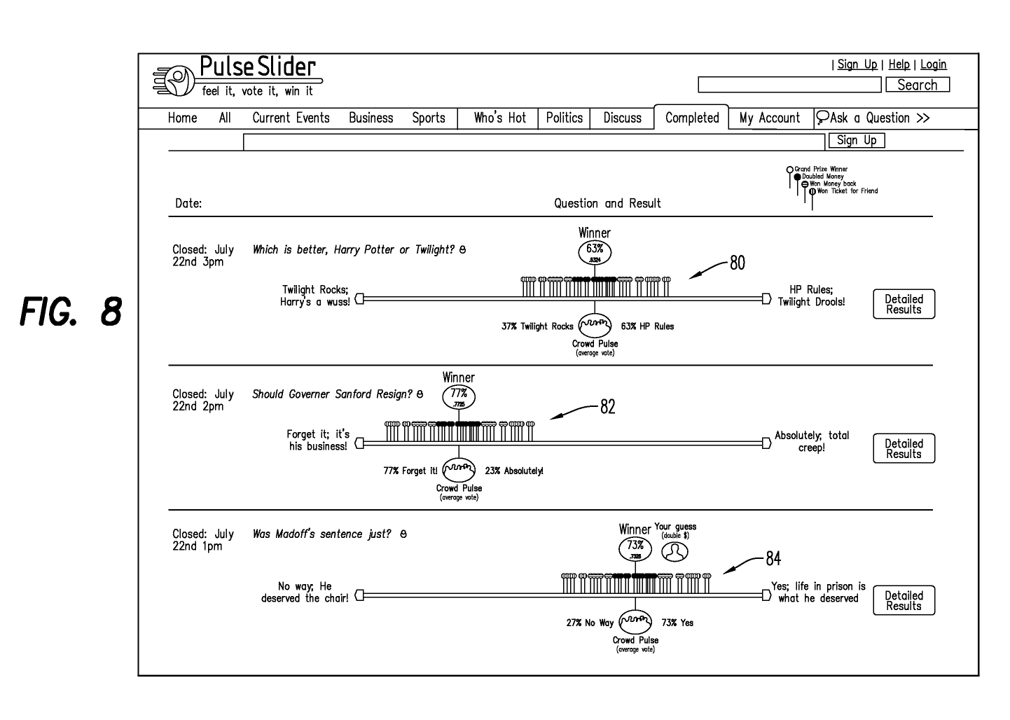

FIG. 8 shows results of after completion of process 200. FIG. 8 may include the most-recently-presented propositions, the propositions for which the current user has submitted an indication/prediction, or any other subset of propositions. Each result includes a graphical representation (80, 82, 84) of the various indications of degrees of agreement received from users. The received indications need not be illustrated individually; other techniques for illustrating the distribution of received indications may be employed. Similarly, each result of FIG. 8 may also or alternatively include a graphical representation (e.g., a distribution) of predictions received from users (e.g., via control 12).

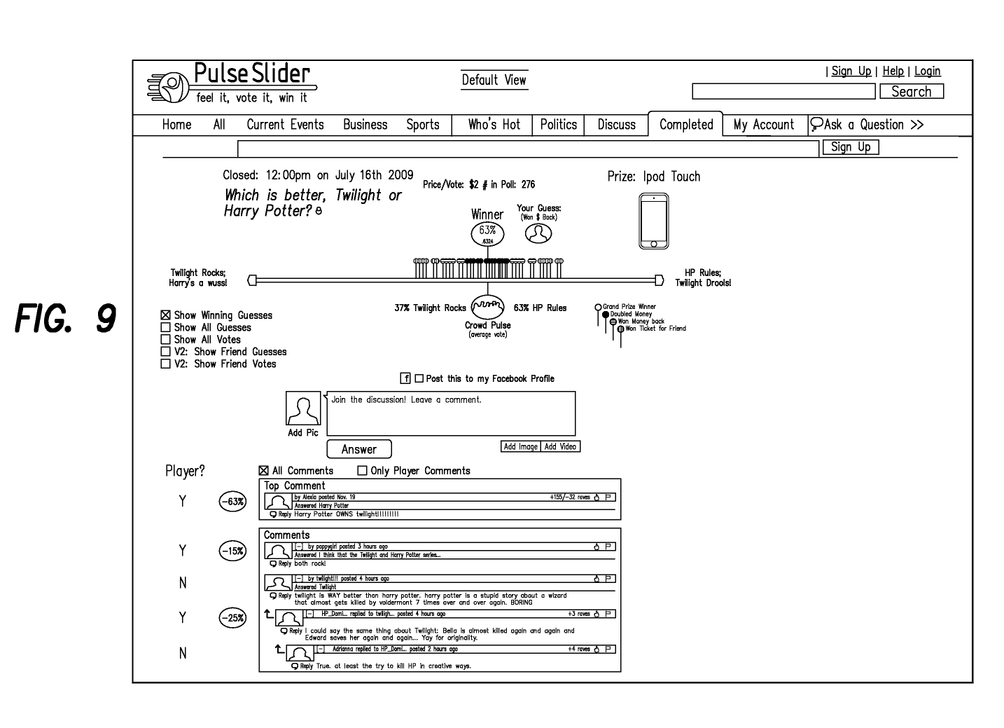

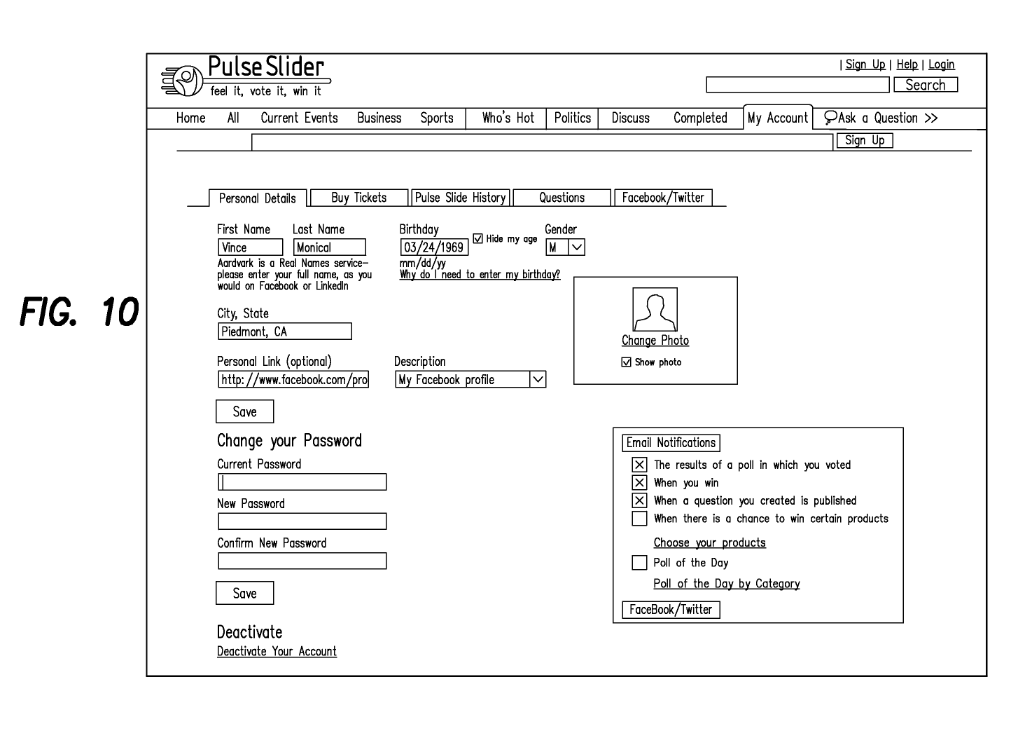

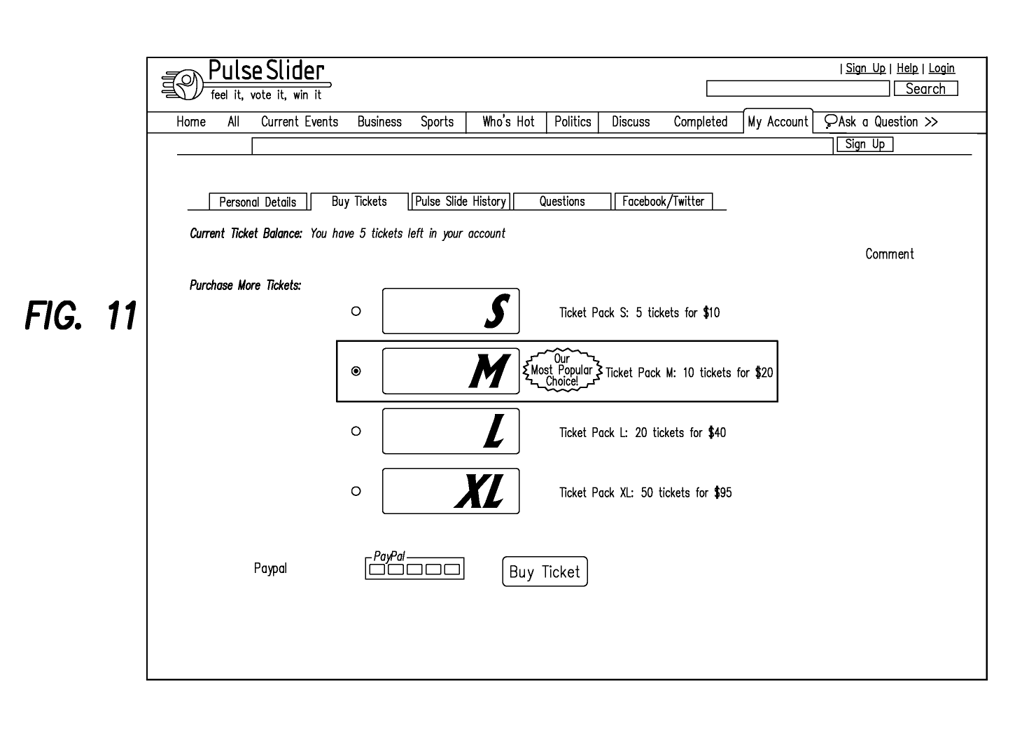

FIG. 9 shows a default view of detailed results of a completed proposition. The default view allows filtering of the displayed user indications according to various characteristics and includes an interface to participate in a related discussion. FIG. 10 shows an interface for managing a user account, including email notification preferences relating to the above-described process. FIG. 11 illustrates an interface for purchasing multiple entries (i.e., “tickets”). Embodiments are not limited to pre-purchased tickets.

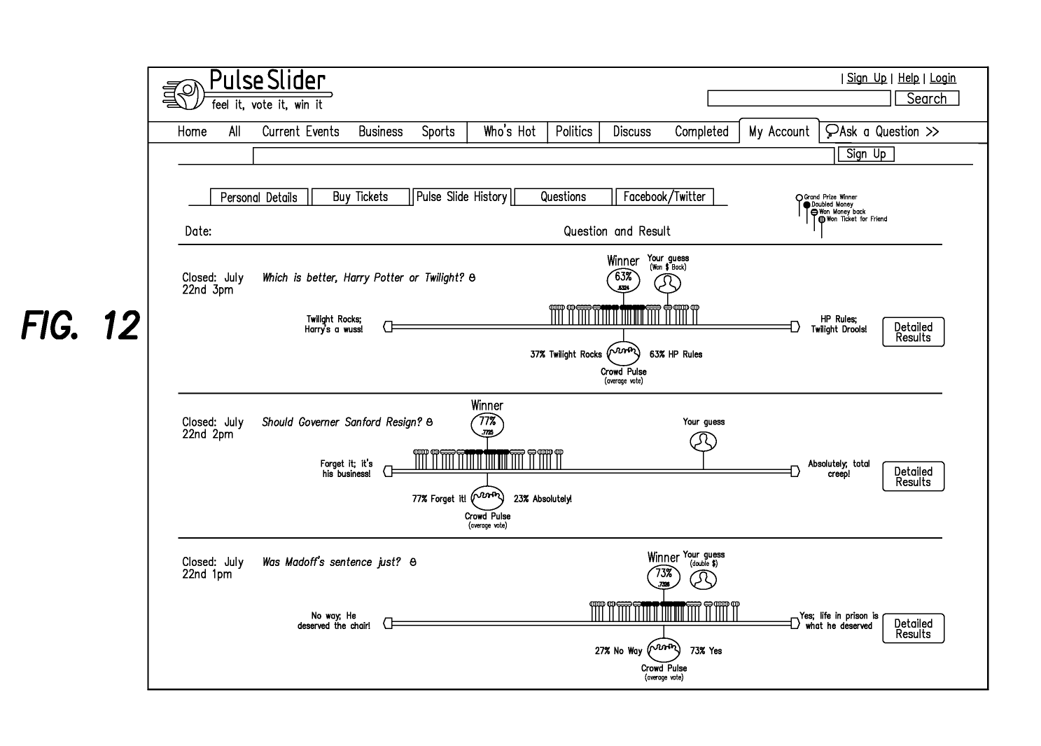

FIG. 12 is similar to FIG. 8, but shows only games in which the current user submitted an indication/prediction, as well as the prediction of current user (i.e., “Your Guess”) and any prizes awarded to the current user. Embodiments of FIG. 12 may also display the indication submitted by the current user for each proposition.

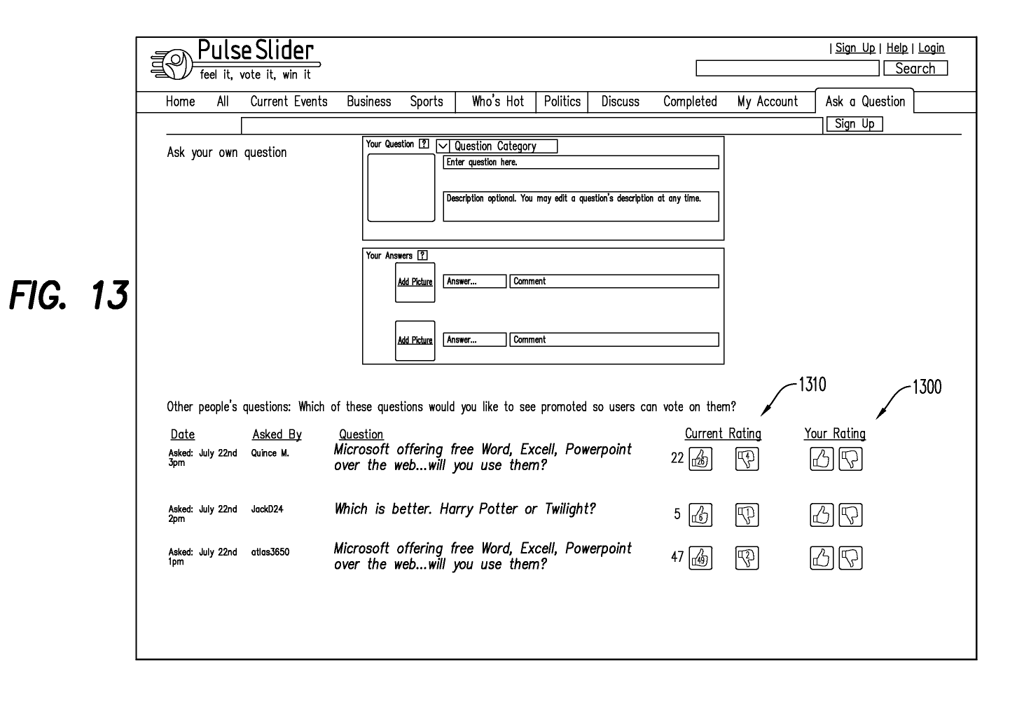

The interface of FIG. 13 allows a user to create a proposition (i.e., “question”) for future presentation to users. For each proposition, the user may also specify two alternative answers. FIG. 13 also shows propositions submitted by other users, voting interface 1300 to allow the current user to vote on the propositions, and graphic 1310 to show the received vote totals. The votes may be used to determine whether to present a user-submitted proposition.

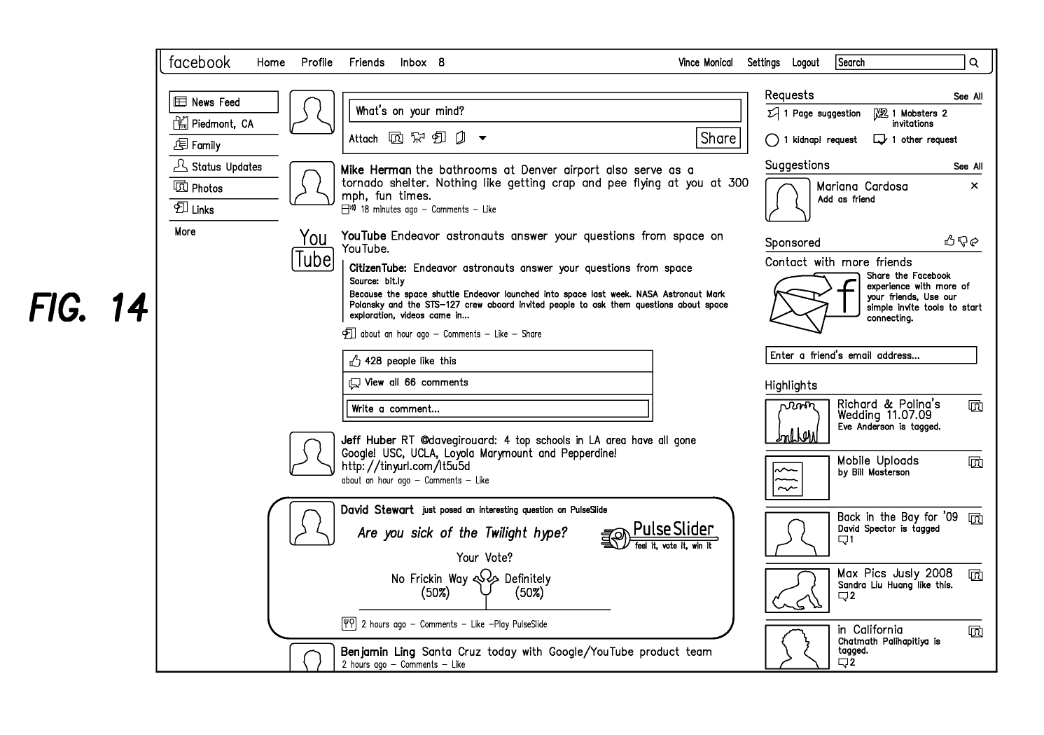

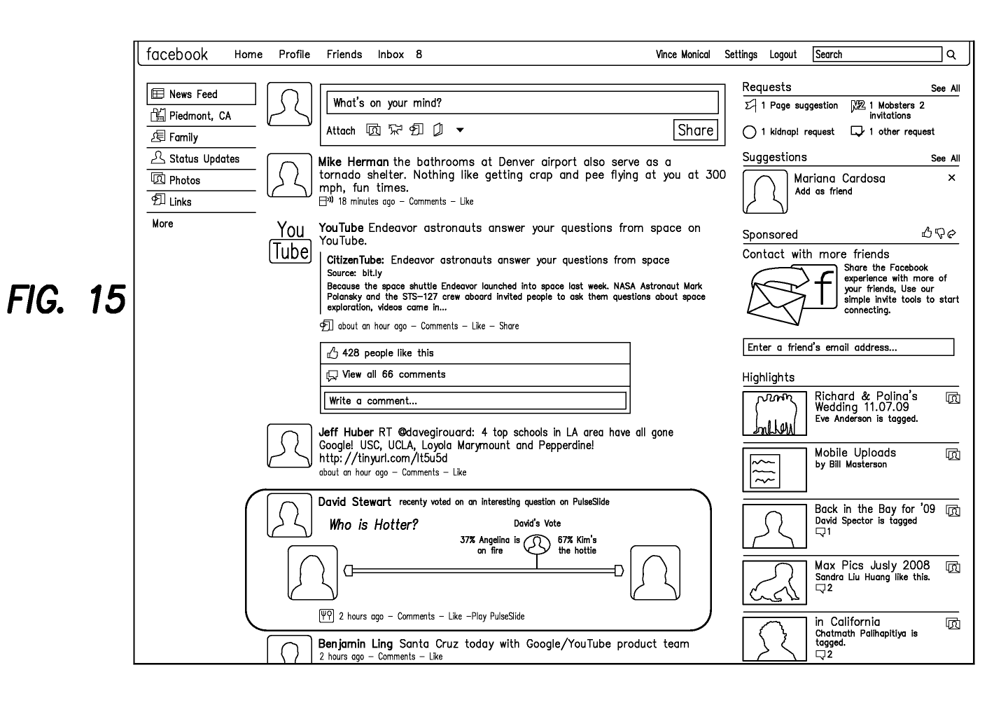

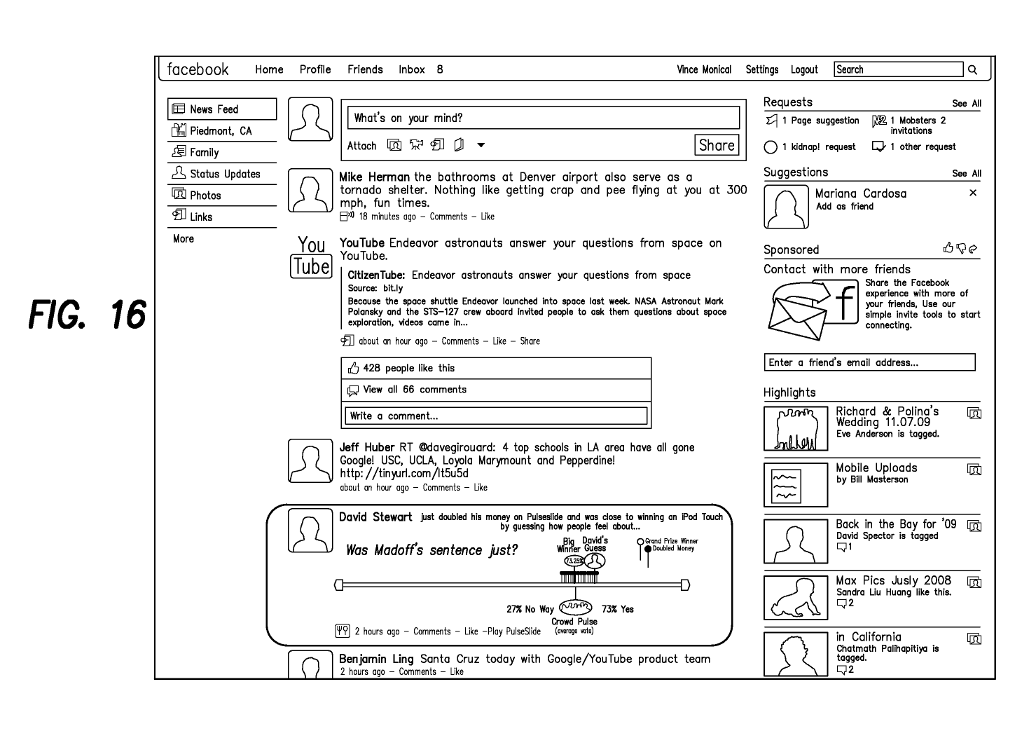

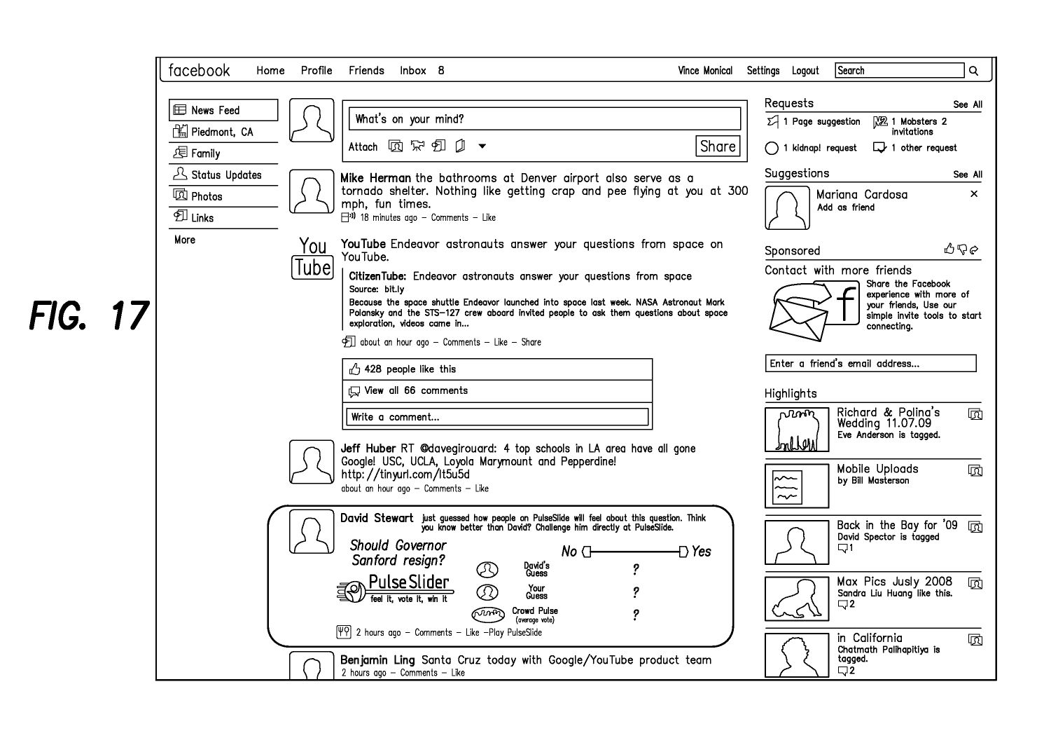

FIGS. 14 through 17 show various examples of integration with a social networking website. For example, a user's activity may be linked with their profile on a social networking website via the FIG. 10 interface. Notifications of the activity may then be pushed to subscribers to the user's profile. These notifications may indicate that the user created a proposition which is currently being presented to users (FIG. 14), that the user submitted an indication of a degree of agreement with respect to an answer to a proposition (FIG. 15), that the user won (and/or was close to winning) a prize (FIG. 16), and that the user submitted a prediction of a composite degree of agreement (FIG. 17). The notifications may include links for submitting an indication/prediction associated with the proposition, and/or for visiting a website providing such functionality.

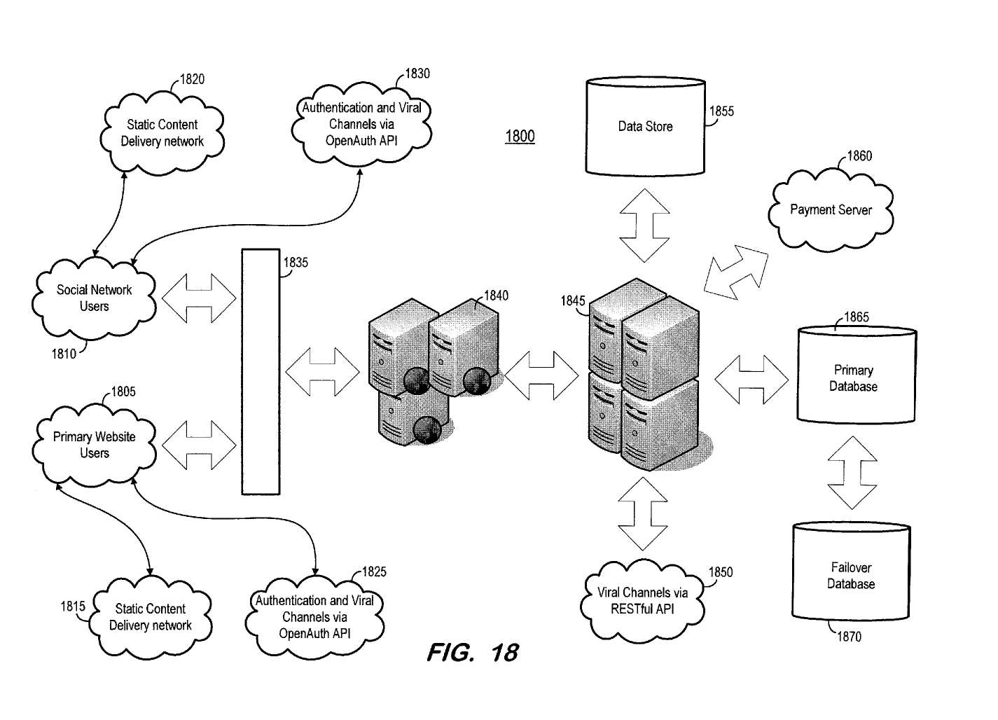

FIG. 18 is a block diagram of architecture 1800 according to some embodiments. Embodiments are not limited to architecture 1800. Each illustrated component of architecture 1800 may be implemented using any suitable combinations of hardware and/or software that are or become known. Functionality of one or more of the illustrated components may be provided by a single hardware device.

Architecture 1800 supports, at least, users 1805 accessing the above-described functionality via a primary website (e.g., www.rocketpolls.com), and users 1810 accessing the functionality via a social network (e.g., Facebook™). Static content delivery network 1815 may provide some data to users 1805. Content delivery network 1815 includes computers storing identical data at various network points. Users 1805 may therefore access a nearby copy of the data, so as to avoid a bottleneck near the central server of the primary website. Similarly, social network users 1810 may receive some requested data from static content delivery network 1820.

Architecture 1800 also supports the delivery of users 1805 from authentication and viral channels 1825 through the OpenAuth API. The OpenAuth API may also be used to deliver additional social network users 1810 from authentication and viral channels 1830 located within the social network.

Load balancer 1835 provides a single service from multiple servers while abstracting the backend separation of functions from users 1805 and 1810. Web server array 1840 (e.g., Apache2 Web servers) receives and processes requests based on Web protocols and may autoscale to meet demand. Application servers 1845 (e.g., FASTCGI servers) execute the core backend application in response to requests received from Web server array 1840. The core backend application may be embodied in program code (e.g., PHP5) executable by one or more processors of servers 1845 to provide the functions (e.g., process 200) described herein. The core backend application may be directly accessed via social network viral channels 1850 via the RESTful Web API.

During operation, application servers 1845 access in-memory, persistent, journaled, key-value data store 1855 (e.g., Redis data store) storing, for example, cached application JavaScript Object Notation responses, cached geolocation data, application usage statistics and purchase session transmission. In this regard, application servers 1845 communicate with payment server 1860 (e.g., Paypal) to process payments such as those described herein.

Primary database 1865 (e.g., MySQL) may store all user information for access by servers 1845. Database 1865 may also store propositions and associated answers and site usage data. Failover database 1870 is a replica of database 1865 and may provide hot failover protection.

The several embodiments described herein are solely for the purpose of illustration. Therefore, persons in the art will recognize from this description that other embodiments may be practiced with various modifications and alterations.

What is claimed is:

1. A method implemented by computer hardware in response to execution of program code by a processor of said computer hardware, the method comprising:
presenting a proposition associated with at least two alternative answers;
receiving, from a user, an indication of a degree of agreement with at least one of the alternative answers, the degree of agreement being greater than zero percent and less than one hundred percent; and
receiving, from the user, a prediction of a composite degree of agreement with at least one of the alternative answers, the composite degree of agreement being greater than zero percent and less than one hundred percent.

2. A method according to claim 1, further comprising:
receiving, from each of a plurality of other users, an indication of a degree of agreement with at least one of the alternative answers, the degree of agreement of each received indication being greater than zero percent and less than one hundred percent; and
determining the composite degree of agreement based on the indications of degrees of agreement received from the plurality of other users.

3. A method according to claim 1, wherein determining the composite degree of agreement comprises:
determining the composite degree of agreement based on the indications of degrees of agreement received from the plurality of other users and the indication of the degree of agreement received from the user.

4. A method according to claim 2, further comprising:
receiving, from each of the plurality of other users, a prediction of a composite degree of agreement with at least one of the alternative answers; and
identifying, from among the received predictions of the composite degree of agreement, a received prediction of the composite degree of agreement that is closest to the determined composite degree of agreement.

5. A method according to claim 4, further comprising:
providing a prize to the user from whom the closest prediction was received.

6. A method according to claim 5, further comprising:
determining the prize based on the number of received predictions of the composite degree of agreement.

7. A method according to claim 1, further comprising:
providing a first substantially-continuous interface control to receive the indication of the degree of agreement; and
providing a second substantially-continuous interface control to receive the prediction of the composite degree of agreement.

8. A system comprising:
an apparatus comprising a processor, the apparatus to:
present a first user interface portion including a proposition associated with at least two alternative answers;
present a second user interface portion to receive, from a user, an indication of a degree of agreement with at least one of the alternative answers, the degree of agreement being greater than zero percent and less than one hundred percent; and
present a third user interface portion to receive, from the user, a prediction of a composite degree of agreement with at least one of the alternative answers, the composite degree of agreement being greater than zero percent and less than one hundred percent.

8. A system according to claim 7, the apparatus further to:
present the second user interface portion to receive, from each of a plurality of other users, an indication of a degree of agreement with at least one of the alternative answers, the degree of agreement of each received indication being greater than zero percent and less than one hundred percent; and
determine the composite degree of agreement based on the indications of degrees of agreement received from the plurality of other users.

9. A system according to claim 7, wherein determination of the composite degree of agreement comprises:
determining the composite degree of agreement based on the indications of degrees of agreement received from the plurality of other users and the indication of the degree of agreement received from the user.

10. A system according to claim 9, the apparatus further to:
present the third user interface portion to receive, from each of the plurality of other users, a prediction of a composite degree of agreement with at least one of the alternative answers; and
identify, from among the received predictions of the composite degree of agreement, a received prediction of the composite degree of agreement that is closest to the determined composite degree of agreement.

11. A system according to claim 10, the apparatus further to:
provide a prize to the user from whom the closest prediction was received.

12. A system according to claim 11, the apparatus further to:
determine the prize based on the number of received predictions of the composite degree of agreement.

13. A system according to claim 7,
wherein the second user interface portion comprises a first substantially-continuous interface control to receive the indication of the degree of agreement, and
wherein the third user interface portion comprises a second substantially-continuous interface control to receive the prediction of the composite degree of agreement.
